(19) United States
(12) Patent Application Publication
(10) Pub. No.: US 2008/0197753 A1
(43) Pub. Date: Aug. 21, 2008

(54) Longitudinal Pulse Wave Array

(76) Inventors: John K. Schneider, Snyder, NY (US); Jack C. Kitchens, Tonawanda, NY (US)

Correspondence Address: HODGSON RUSS LLP;THE GUARANTY BUILDING, 140 PEARL STREET, SUITE 100, BUFFALO, NY, 14202-4040, US

(21) Appl. No.: 12/110,876

(22) Filed: Apr. 28, 2008

Related U.S. Application Data
(63) Continuation-in-part of application No. 11/754,131, filed on May 25, 2007.
(60) Provisional application No. 60/803,150, filed on May 25, 2006.
(60) Provisional application No. 60/822,087, filed on Aug. 11, 2006.
(60) Provisional application No. 60/914,203, filed on Apr. 26, 2007.

(51) Int. Cl. H02N 2/00

(52) U.S. Cl. 310/322

(57) ABSTRACT

An acoustic pulse array is described. The pulse array may include a plane wave pulse generator having a first side from which a first wave emanates, and a second side from which a second wave emanates. A first waveguide array may be attached to the generator on the first side of the generator, and a second waveguide array may be attached to a second side of the generator. One or more of the waveguides may be attached to the generator so as to orient the waveguide to transmit wave pulses in a direction that is substantially perpendicular to the generator.

### CROSS-REFERENCE TO RELATED APPLICATION

This application is a continuation-in-part of U.S. patent application Ser. No. 11/754,131, filed May 25, 2007, which in turn claims priority to U.S. provisional patent application Ser. No. 60/803,150 (filed May 25, 2006) and Ser. No. 60/822,087 (filed Aug. 11, 2006). In addition, this application claims the benefit of priority to U.S. provisional patent application Ser. No. 60/914,203, filed on Apr. 26, 2007.

### FIELD OF THE INVENTION

The present invention relates to an acoustic pulse array and, more specifically, to a flat panel acoustic pulse array employing piezoelectric pulse generating means. In this document the term “acoustic” is used to refer to a longitudinal wave, such as an ultrasound wave, even though the wave may not be audible.

### BACKGROUND OF THE INVENTION

Existing acoustic imaging systems make use of single-pixel-scanning techniques and phased array techniques. These techniques result in imaging systems that are bulky and cumbersome.

### SUMMARY OF THE INVENTION

The invention may be embodied as an acoustic pulse array. The pulse array may include a plane wave pulse generator (sometimes referred to herein as an “acoustic wave generator”) having a first side from which a first wave emanates, and a second side from which a second wave emanates. A first waveguide array may be attached to the generator on the first side of the generator, and a second waveguide array may be attached to a second side of the generator. One or more of the waveguides may be attached to the generator so as to orient the waveguide to transmit wave pulses in a direction that is substantially perpendicular to the acoustic wave generator.

The acoustic wave generator may include a piezoelectric film and two electrodes. A first one of the electrodes may be bonded to a first side of the film, and may substantially cover a first side of the film. A second one of the electrodes may be bonded to a second side of the film and may substantially cover a second side of the film. The first waveguide array may be attached to the first electrode, and/or the second waveguide array may be attached to the second electrode.

Each waveguide array may be comprised of a plurality of waveguides, each waveguide having a core material and cladding material. Within a waveguide array, the cladding material of one waveguide may be fused with the cladding material of another waveguide. The core and cladding material may be selected so that acoustic energy may be conveyed using internal reflection within a waveguide.

An acoustic pulse array according to the invention may be used to produce and send acoustic energy toward a target object where some of the energy is reflected by the target object. The reflected acoustic energy may be guided by the waveguide arrays to a detector, which may have an appropriate number of acoustic energy receiving elements. In doing so, crosstalk between waveguides in an array, signal loss from a waveguide array, and interference from outside the waveguide array may be minimized. At the detector, the acoustic energy may be converted to an electric signal, and that electric signal may be used to create a grayscale image.

### BRIEF DESCRIPTION OF THE DRAWINGS

For a fuller understanding of the nature and objects of the invention, reference should be made to the accompanying drawings and the subsequent description. Briefly, the drawings are:

FIG. 1 is an exploded perspective view of an acoustic pulse array that is in keeping with the invention;

FIG. 2A is a top view of an acoustic pulse array that is in keeping with the invention;

FIG. 2B is a side view of the acoustic pulse array depicted in FIG. 2A;

FIG. 2C is an enlarged view of a portion of the acoustic pulse array depicted in FIG. 2A;

FIG. 3A shows a side-view of an acoustic waveguide;

FIG. 3B shows an end-view of the acoustic waveguide depicted in FIG. 3A; and

FIG. 4 is a schematic representation showing the travel of a single element pulse at different times and different fibers within the acoustic pulse array. Also shown are a target object and an acoustic detector array that can receive the acoustic pulses.

### FURTHER DESCRIPTION OF THE INVENTION

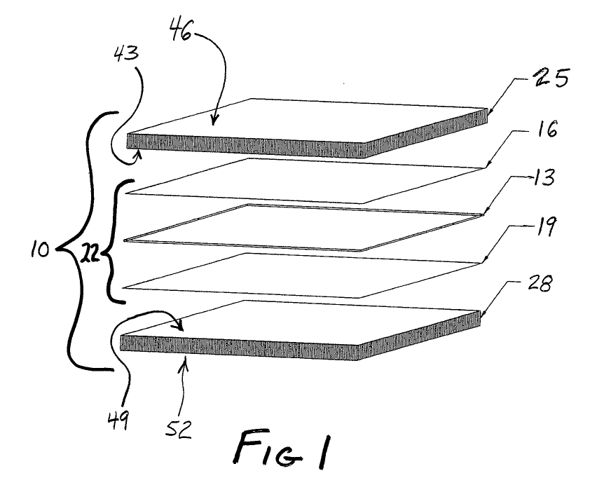

FIG. 1 shows components of an acoustic pulse array 10 that is in keeping with the invention. A piezoelectric film 13 may be positioned between a first electrode 16 and a second electrode 19. The piezoelectric film 13 may be polyvinylidenefluoride (“PVDF”) polymer or polyvinylidene fluoride trifluoroethylene (“PVDF-TrFE”) and the electrodes 16, 19 may be metalized films of silver, indium-tin-oxide, chrome-gold, gold or some other conductive material. The electrodes 16, 19 may be vacuum sputtered to the piezoelectric film 13. The combination of the piezoelectric film 13 and the electrodes 16, 19 is referred to herein as acoustic wave generator (“AWG”) 22. The AWG 22 may be positioned between a first waveguide array 25 and a second waveguide array 28. Each waveguide array 25, 28 has the ability to convey acoustic energy from one side of the array to another side of the array. The waveguide arrays 25, 28 may be attached to the AWG 22 by an adhesive 30, such as epoxy or cyanoacrylate, residing between the waveguide arrays 25, 28 and their respective electrodes 16, 19, or by squeezing the AWG 22 together by simple compression or clamping.

By placing the AWG 22 between two waveguide arrays 25, 28, the AWG 22 (and particularly the piezoelectric film 13) is reinforced. Without such reinforcement, creation of the pulses may be unbalanced, and the AWG 22 will create a signal having a frequency that is half the frequency at which the AWG 22 is oscillating. For example, if the AWG 22 is attached to only a single waveguide array and the film 13 is oscillated at 30 MHz, the frequency of the signal emanating toward a target object 31 would be 15 MHz. But, by attaching the AWG 22 to two waveguide arrays 25, 28, the piezoelectric film 13 will produce a 30 MHz signal emanating toward a target object 31.

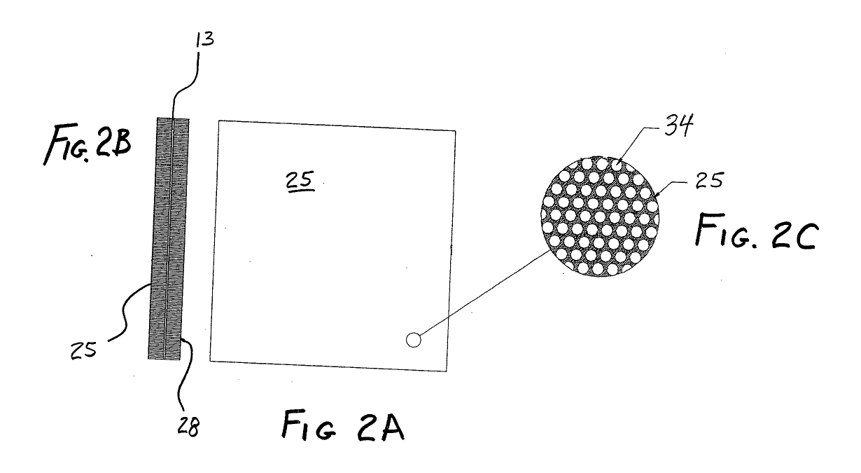

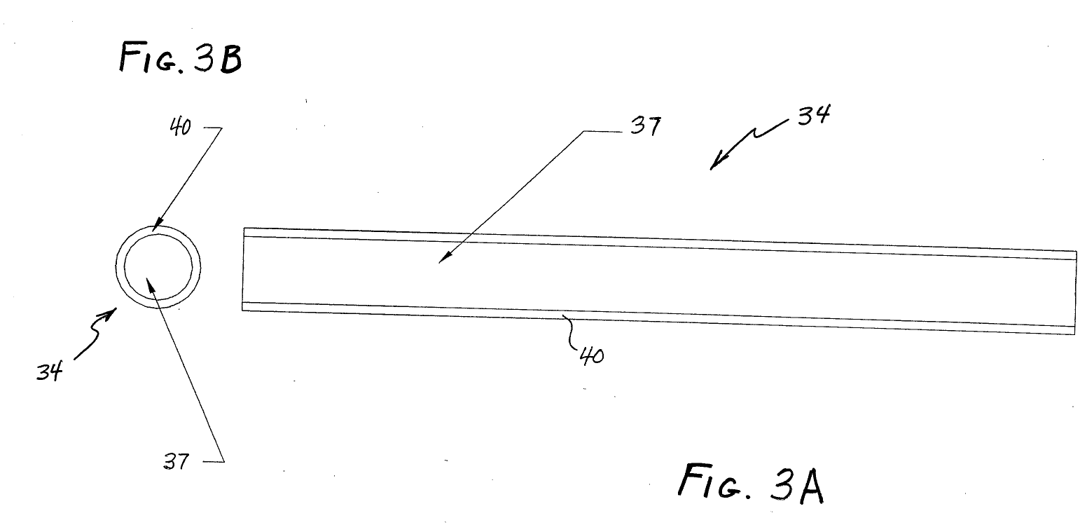

Each waveguide array 25, 28 may be comprised of a plurality of waveguides 34. FIGS. 2A, 2B and 2C depict a waveguide array, and FIGS. 3A and 3B depict a waveguide 34. Each waveguide 34 may be thought of as a fiber having a core material 37 and a cladding material 40. The core material 37 and cladding material 40 are selected to have different abilities to transmit acoustic waves. The core material 37 is selected to have an acoustic wave transmission velocity that is substantially higher than the acoustic wave transmission velocity in the cladding material 40. For example, the core may be polystyrene and the cladding may be optical grade polymethylmethacrylate. As such, an acoustic wave traveling through the acoustic waveguide is conducted by means of total internal reflection at the interface of the two different materials 37, 40. Taken together, these two materials 37, 40 function as a coherent acoustic waveguide, and a plurality of such waveguides 34 may be combined to form a plate of waveguides, i.e., an array 25, 28 of acoustic waveguide elements.

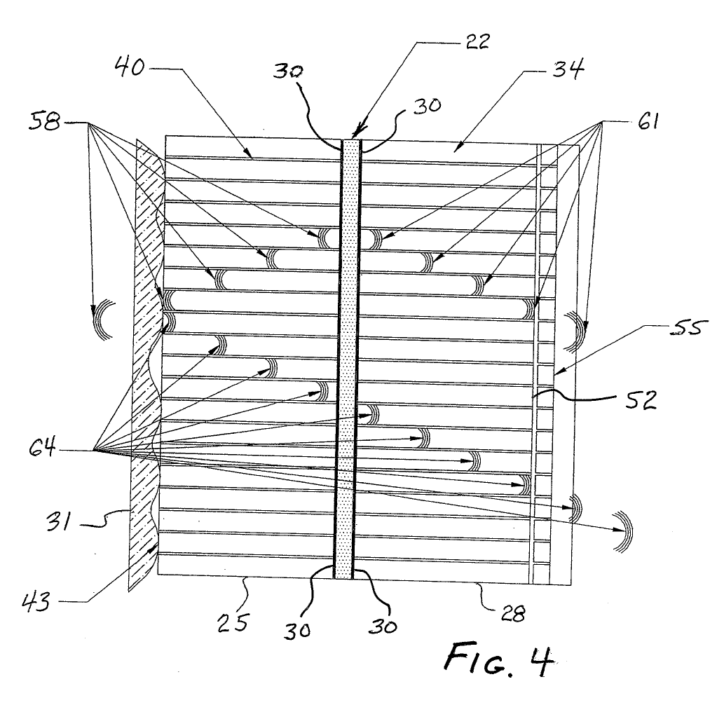

With reference to FIG. 4, when the AWG 22 issues an ultrasonic pulse of energy, the first waveguide array 25 conducts ultrasonic energy from a first side 43 of the first waveguide array 25, through the individual acoustic waveguide elements 34 to the second side 46 of the first waveguide array 25. When the ultrasonic energy reaches the second side 46 of the first waveguide array 25, the energy is provided to a target object 31, such as a finger having a fingerprint. Some of the energy may continue on or be scattered and the balance will be reflected back through the fibers 34 of the first waveguide array 25, where the reflected energy passes through the AWG 22 and enters the second waveguide array 28. The reflected ultrasonic energy will be conducted from a first side 49 of the second waveguide array 28, via the waveguide elements 34 of the second waveguide array 28, to a second side 52 of the second waveguide array 28. At this point the reflected acoustic energy being emitted from the second side 52 of the second waveguide array 28 may be detected by a suitable acoustic detector 55 that may be fixed relative to the acoustic pulse array 10.

It should be noted that some of the ultrasonic energy produced by the AWG 22 will pass into the waveguide arrays 25, 28, but not into the cores 37 of the waveguide elements 34. For example, the acoustic energy that does not enter the core 37 of a waveguide element 34 may enter the cladding 40 of a waveguide element 34, or another material that is used to hold the waveguide elements 34 to each other. Energy that does not travel through the core material 37 may be absorbed, diffused and/or dissipated, where it will not be available to interfere with the primary energy pulse and echoes that travel within the acoustic waveguide fibers 34 (i.e. along the core material 37).

To cause the AWG 22 to produce an ultrasonic pulse, an electric field may be created between the electrodes 16, 19. This causes the piezoelectric film 13 to generate a pair of pulses 58, 61 of acoustic energy. The two pulses 58, 61 initially travel in different directions—a first one of the pulses 58 travels toward the first waveguide array 25 and a second one of the pulses 61 travels toward the second waveguide array 28. The second acoustic pulse 61, which contains no useful information about the target 31, arrives at the detector 55 and may be ignored by the acoustic detector array 55. The first acoustic pulse 58 travels through the first waveguide array 25 until it reaches the target object 31 or is reflected back by some other surface. The target object 31 may be the friction ridge surface of a finger. The reflected energy 64 travels back through the first waveguide array 25, passes through the two electrodes 16, 19 and the piezoelectric film 13, and then through the second waveguide array 28. The reflected pulse energy 64 provided by the second waveguide array 28 is then received by the detector 31, where the reflected pulse energy 64 may be converted to an electrical signal, such as a voltage signal, which may then be processed by electric circuits that monitor the acoustic detector array. The electric signal may be used to create an image of the object that reflected the energy.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A pulse array, comprising:
a plane wave pulse generator having a first side from which a first wave emanates, and a second side from which a second wave emanates;
a first waveguide array attached to the generator on the first side; and
a second waveguide array attached to the generator on the second side.

2. The pulse array of claim 1, wherein the generator includes a piezoelectric film.

3. The pulse array of claim 2, wherein the generator includes an electrode substantially covering a side of the piezoelectric film.

4. The pulse array of claim 3, wherein the first waveguide array is attached to the electrode by an adhesive.

5. The pulse array of claim 2, wherein the generator includes a first electrode substantially covering a first side of the film, and a second electrode substantially covering a second side of the film.

6. The pulse array of claim 5, wherein the first waveguide array is attached to the first electrode, and the second waveguide array is attached to the second electrode.

7. The pulse array of claim 2, wherein the first waveguide array is oriented to transmit wave pulses from the generator in a direction that is substantially perpendicular to the piezoelectric film.

8. The pulse array of claim 1, wherein the first waveguide array is comprised of a plurality of waveguides, each waveguide having a core material and cladding material.

9. The pulse array of claim 8, wherein the cladding material of one waveguide has been fused with the cladding of another waveguide.
